(19) United States
(12) Patent Application Publication
(10) Pub. No.: US 2004/0252826 A1
(43) Pub. Date: Dec. 16, 2004

(54) Echo canceller and a method of cancelling echo

(76) Inventors: Wen Shun Tian, Singapore (SG); Antonio Mario Alvarez-Tinoco, Singapore (SG)

Correspondence Address: SEED INTELLECTUAL PROPERTY LAW GROUP PLLC, 701 FIFTH AVENUE, SUITE 6300, SEATTLE, WA, 98104-7092, US

(21) Appl. No.: 10/477,966

(22) PCT Filed: May 17, 2001
(86) PCT No.: PCT/SG01/00093

(51) Int. Cl. H04M 9/08; H04M 1/00

(52) U.S. Cl. 379/406.08; 379/392.01

(57) ABSTRACT

In a communications system having incoming communications signals and outgoing communications signals the outgoing communications signals may undesirably include an echo signal derived from the incoming communications signals. Accordingly, echo cancellation techniques may be applied in the communications system, including generating weighting filter coefficients based on linear prodictive coding coefficients calculated from a block comprising a plurality of sequential samples of the incoming communications signals. The incoming communications signals are filtered through a weighting filter utilising the weighting filter coefficients to produce a weighted incoming communications signals. Estimated echo signals are generated by filtering the incoming communications signals through an adaptive transversal filter, the adaptive transversal filter using adaptive filter coefficients. Then, the estimated echo signals can be subtracted from the outgoing communications signals to produce error signals. Advantageously, the adaptive filter coefficients are determined for each sample in said block on the basis of the weighted incoming communications signals and the error signals.

This invention relates to an echo canceller and a method of cancelling echo.

An adaptive filter may be used to cancel echo such as in communications systems. In an adaptive filter, characteristics of the filter are adaptively modified so that an output signal, generated from an applied input signal by action of the filter to filter the input signal, is conformed so as to tend to bear a particular relationship to the input signal, in accordance with a control input. In communications systems, for example, an echo signal may arise at interface circuitry which receives incoming signal on an incoming path of a four wire link due to part of the incoming signal being redirected, through the circuitry, to an outgoing part of the four wire link, rather than, as is intended, the whole of that signal being directed to a two wire link to which the interface circuitry is connected. The part signal is thus present in the outgoing signal from the interface circuitry, being directed back to the far end of the four wire link, to appear as a delayed “echo” signal. In this application, the input of the filter may be connected to receive the incoming signal and the output is connected to a subtractor which is also connected to receive the outgoing signal from the interface circuitry. The subtractor generates an outgoing signal, for transmission on the outgoing signal path, which is the result of subtraction of the output of the filter from the signal from the interface circuitry. The resultant outgoing signal is used to adjust the filter characteristics to minimise the echo signal. Adaptive filters may be used in analogous applications such as in cancelling acoustic echo occurring in full duplex communications systems.

Generally, in an adaptive filter, filter coefficients are repetitively updated to effect updating of the filter characteristics so that effective echo cancellation occurs even though the circuit characteristics of the communications link change.

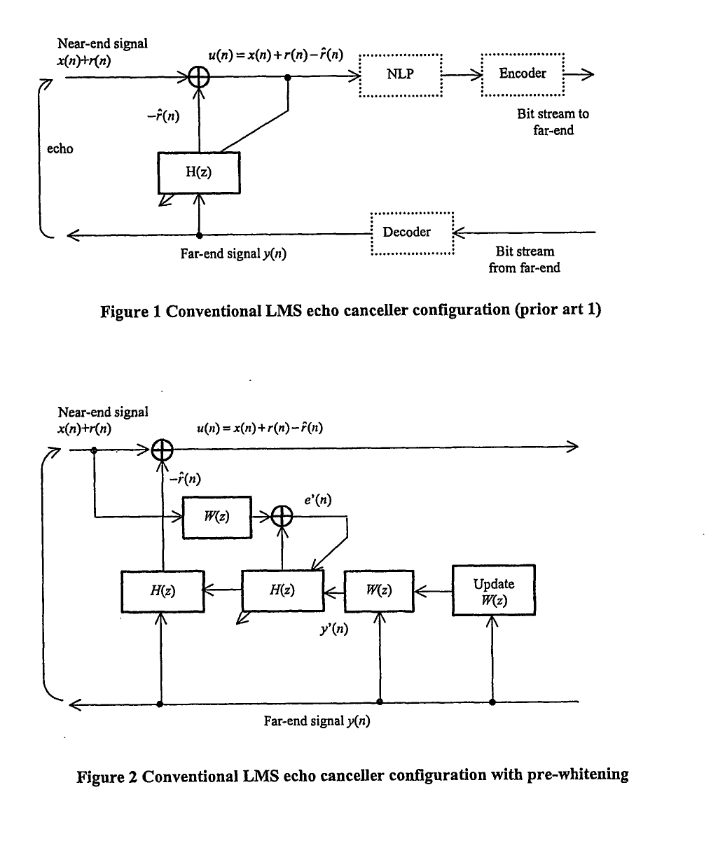

Customarily in acoustic or line echo cancellation, either an LMS (Least Mean Square) or NLMS (Normalised LMS) method is used: An LMS echo canceller typically has one adaptive filter whose coefficients are updated sample-by-sample. FIG. 1 shows such a conventional echo cancellation structure in block diagram form. As shown in the figure, a first communications channel 10 carries a far-end signal y(n) to a near-end interface 30, and a second communications channel 20 carries a near-end signal x(n) back to the far-end of the communications system. In view of imperfect coupling at the near-end interface 30, the second communications channel 20 also carries an echo signal r(n), which is undesirable. Accordingly, an adaptive filter 40 and signal adder 50 are included to effect at least partial cancellation of the echo signal r(n). The signal adder 50 is coupled into the second communications channel 20, and adds the signal from the near-end interface 30 with a signal from the adaptive filter 40 which is an estimate of the echo signal which is desired to be cancelled. The output from the signal adder 50 on the second communications channel 20 is represented by u(n). The blocks indicated with dotted lines represent functional components included for forming a line echo canceller (LEC). For acoustic echo cancellers (AEC), these components may not be present.

With reference to FIG. 1, the transversal filter coefficient updating and filtering are described by the following equations.

Adaptive filter coefficients updating:

hₖ(n+1)=hₖ(n)+2μ.e(n).y(n−k)/P_{y}(n) (1)

where hₖ(n) are the filter coefficients in time index n and filter tap k, y(n) is far-end signal, e(n) is the u(n) when there is no near-end talking, μ is the step size, P_{y}(n) is the power of far-end signal which is given by

P_{y}(n)=(1−α)P_{y}(n−1)+α.y(n)² (2)

where α is the power normalised parameter, chosen according to the size of NLMS.

The estimated echo signal is given by

$$\hat{r} ( n ) = {y ( n )}^{*} {h}_{k} ( n ) = {\sum }_{k = 0}^{N - 1} {h}_{k} ( n ) y ( n - k ) \qquad ( 3 )$$

where y(n) is far-end signal and N is the length of the filter.

Finally the echo cancelled signal u(n) is given by

u(n)=x(n)+r(n)−\hat{r}(n) (4)

where x(n) is the near-end speech and r(n) is the echo from the echo path plus the additive noise. If there is no near-end-talk, u(n) becomes e(n) given by

e(n)=r(n)−\hat{r}(n) (5)

This error signal is used to update the transversal filter coefficients for the next sample.

This NLMS algorithm is same for both LEC and AEC. A control module for double talking detection and freeze control may be employed, but are not described here, since this may be of conventional form.

These conventional filter algorithms can be found, for example, in Simon Haykin, “Adaptive Filter Theory”, Third Edition, Prentice Hall, 1996, and Texas Instruments, “Acoustic Echo Cancellation-Algorithm and Implementation on the TMS320C8X”, Application Report, 1996.

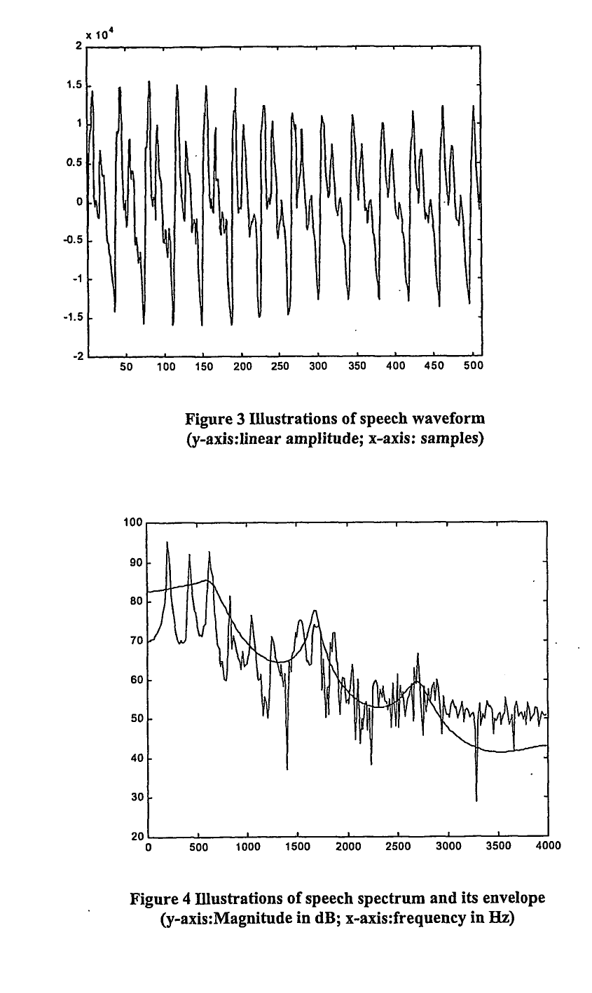

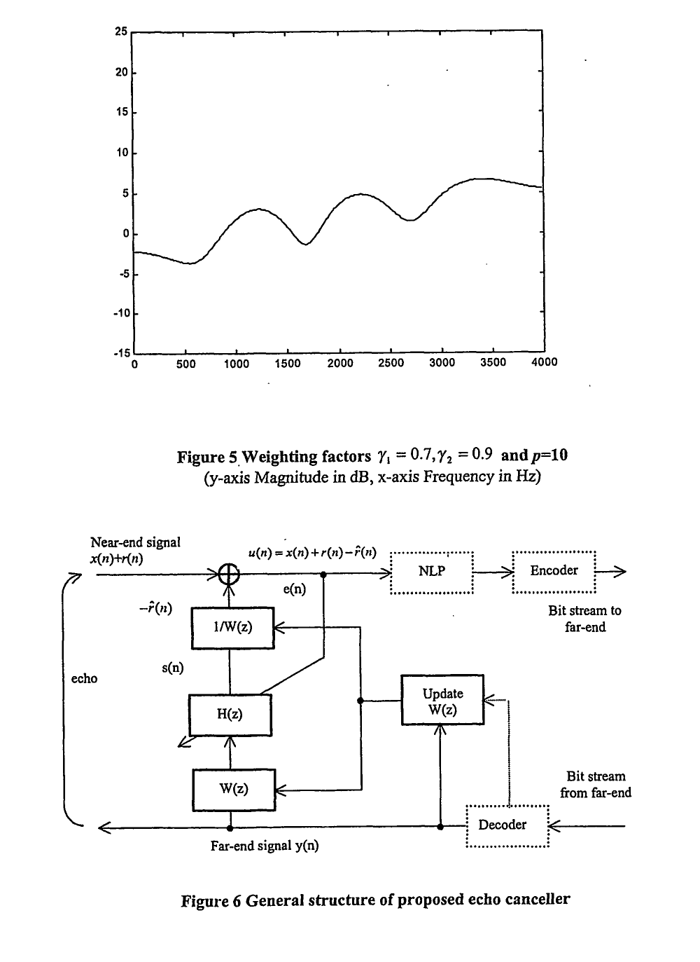

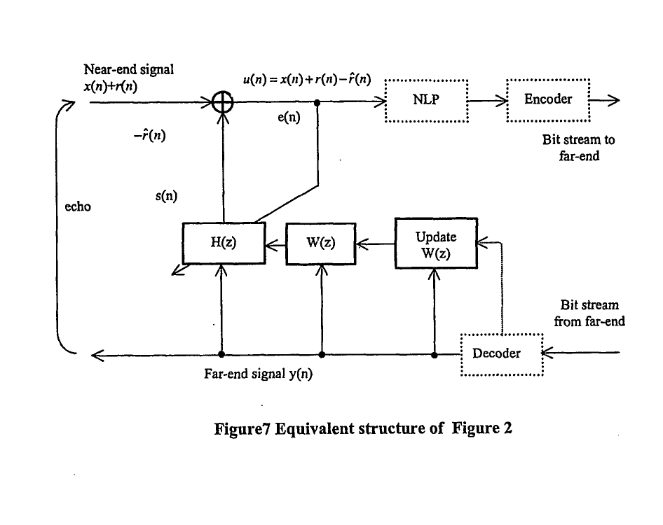

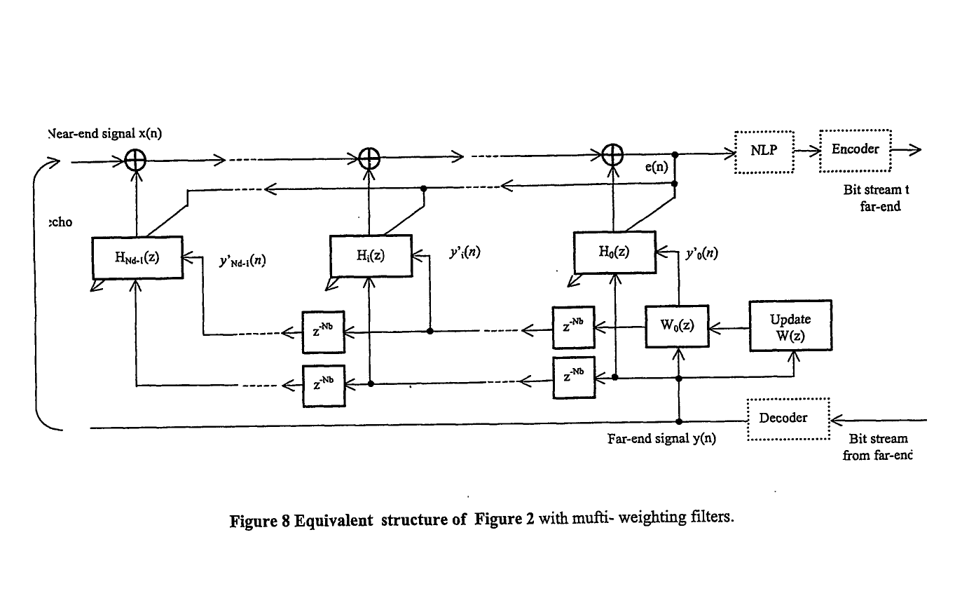

A system employing pre-whitening of the far-end signal is shown in block diagram form in FIG. 2. In this system, a Levinson-Durbin algorithm is used to calculate whitening filter coefficients. The decorrelated far-end and residual signals are used to update the transversal filter coefficients using NLMS method. Adaptive filter coefficients are updated as following.

hₖ(n+1)=hₖ(n)+2μ.e′(n).y′(n−k)/P_{y}(n) (6)

where the modified far-end, echo signals, error signals are calculated by

$$\begin{matrix}{y}^{′} ( n ) = {y ( n )}^{*} w ( n ) = {\sum }_{k = 0}^{{N}_{w} - 1} w ( k ) y ( n - k ) & ( 7 ) \\ {r}^{′} ( n ) = {r ( n )}^{*} w ( n ) = {\sum }_{k = 0}^{{N}_{w} - 1} w ( k ) r ( n - k ) & ( 8 )\end{matrix}$$

e′(n)=r′(n)−\hat{r}′(n) (9)

where w(n) is the FIR filter coefficients which is estimated in intervals of about 16 ms using the Levinson-Durbin algorithm.

The power is estimated using the modified far-end signal which is given by

P_{y}(n)=(1−α)P_{y}(n−1)+α.y′(n)² (10)

The modified estimated echo signal is given by

$${\hat{r}}^{′} ( n ) = {{y}^{′} ( n )}^{*} {h}_{k} ( n ) = {\sum }_{k = 0}^{N - 1} {h}_{k} ( n ) {y}^{′} ( n - k ) \qquad ( 11 )$$

For transversal filtering, the estimation of echo is given by:

$$\hat{r} ( n ) = {y ( n )}^{*} {h}_{k} ( n ) = {\sum }_{k = 0}^{N - 1} {h}_{k} ( n ) y ( n - k ) \qquad ( 12 )$$

as in equation (3).

The echo cancelled signal is given by

u(n)=x(n)+r(n)−\hat{r}(n) (13)

In FIG. 2, the two filters H(z) have same set of coefficients. The right-hand one is used to update its coefficients using a whitened error e′(n) signal and a far-end y′(n) signal. The updated coefficients are passed to the left-hand side as shown in FIG. 2, and the left-hand adaptive filter takes y(n) as its input to estimate the echo. Finally, u(n) is sent to the far-end.

This technique is described, for example, in Rudi Frenzel and Marcus E. Henecks, “Using Pre-Whitening and Step Size Control to Improve the Performance of the LMS Algorithm for Acoustic Echo Compensation”, IEEE International Symposium on Circuits and Systems, Vol 4, pp 1930-1932, New York, 1992.

In speech coding, a perceptual weighting technique may be used. In this system, a time-varying short-term prediction filter A(z) is used to produce synthesised speech. Updating of this filter's coefficients is done on a frame-by-frame basis. A frame of speech samples (120 to 240 samples) is buffered and, using conventional Levinson-Durbin recursion, a set of short-term LPC coefficients is computed. The buffered speech samples may be either the original speech (for AEC applications) or reconstructed speech (for LEC applications). The speech or audio signal's synthesis filter is given by

$$\frac{1}{1 - A ( z )} = \frac{1}{1 - {\sum }_{l = 1}^{p} a ( i ) {z}^{- 1}} \qquad ( 14 )$$

where a(i) is the short-term LPC coefficients and p is the LPC filter order. An example is illustrated in FIG. 3 and FIG. 4. FIG. 3 shows a speech waveform and FIG. 4 shows the speech spectrum and its envelope. The diagram in FIG. 3 is graduated according to linear amplitude in the vertical axis and number or samples in the horizontal axis. The diagram in FIG. 4 has a vertical axis graduated according to magnitude in decibels (dB) and a horizontal axis corresponding to frequency in Hertz.

A reduction in amplitude of peaks is possible if the speech spectrum is shaped by a conventional perceptual weighting formant (high energy) filter. This is not for perceptual weighting applications, but to produce whitening effect. The synthesis filter in Equation (14) is used to construct the perceptual weighting filter. The formant weighting filter has a transfer function:

$$W ( z ) = \frac{1 - A ( z / {γ}_{1} )}{1 - A ( z / {γ}_{2} )} = \frac{1 - {\sum }_{l = 1}^{p} a ( i ) {z}^{- 1} {γ}_{1}^{l}}{1 - {\sum }_{l = 1}^{p} a ( i ) {z}^{- 1} {γ}_{2}^{l}} \qquad ( 15 )$$

where γ₁ and γ₂ are bandwidth expansion factors between 0 and 1. Typical values are γ₁=0.7, γ₂=0.9. One example of the whitening filter frequency response is shown in FIG. 5. To simplify this auto-recursive moving average (ARMA) filter with FIR filter, its impulse response is calculated and truncated with N_{w} samples. The inputs response is denoted by h_{w}(n), n=o, . . . , N_{w}−1}, where N_{w} is the length of the weighting filter. A typical value might be 2p.

A perceptual weighting technique is described in A. M. Kondoz, “Digital Speech-Coding for Low Bit Rate Communications Systems”, John Wiley & Sons, 1995.

For conventional echo cancellation, as described with reference to FIG. 1, it is difficult to track the echo-path and converge if the echo tail length is long and the input signal is highly correlated. The described pre-whitening technique may improve the convergence speed, but the ELRE in the steady state may be affected. This is because the target error signal in Equation (9), which is used to calculate the gradient, is not the final error signal as in Equation (5), which is sent to near-end as echo cancelled signal. Minimising |e′(n)|² is not equivalent to minimising |e(n)|², while e(n) or u(n) is the signal sent to the far-end user.

This proposed method is especially suitable for LPC vocoders in LEC applications, such as those known as G.723.1 and G.729. This is because the LPC coefficients are available at the decoder and do not need not to be calculated.

In one aspect, the invention provides an echo canceller for use in a communications apparatus having an incoming far-end signal and a near-end signal which may include an echo component derived from the far-end signal, the echo canceller including an echo estimator for generating an estimated echo signal, and a signal subtracting means for subtracting the estimated echo signal from said rear-end signal to generate a compensated near-end signal including an echo error signal component, wherein said echo estimator includes a weighting filter arranged to provide a whitened far-end signal by weighted filtering of the incoming far-end signal, and a weighting filter coefficient processor which determines coefficients for the weighting filter according to linear predictive coding coefficients derived dynamically from the incoming far-end signal, the echo estimator further including an adaptive transversal filter having adaptive coefficients determined according to said whitened far-end signal and said error signal component, said adaptive transversal filter being operative to generate said estimated echo signal by filtering said far-end signal using said adaptive coefficients.

In another aspect, there is provided a communications apparatus including:

an encode/decode processor which generates outgoing signals from compensated near-end signal data for transmission by way of a communications channel and generates far-end signal data from incoming signals received by way of said communications channel; and

an echo cancellation processor coupled to the encode/decode processor for generating estimated echo signal data and subtracting the estimated echo signal data from near-end signal data so as to obtain said compensated near-end signal data, the echo cancellation processor including:

a weighting filter arranged to produce whitened far-end signal data by weighted filtering of said far-end signal data using weighting filter coefficients;

a weighting filter coefficient processor which determines said weighting filter coefficients according to linear predictive coding coefficients derived from the far-end signal data;

an adaptive transversal filter having adaptive coefficients determined according to said whitened far-end signal data and an echo error component obtained from said compensated near-end signal data, said adaptive transversal filter being operative to generate said estimated echo signal data by filtering said far-end signal data using said adaptive coefficients.

In another aspect, there is provided an echo compensation processor for use in a communications system in which outgoing signal data for transmission by way of a communications channel comprises near-end signal data x(n) and an echo component r(n) derived from far-end signal data y(n) received by way of said communications channel, the echo compensation processor being coupled to receive said far-end signal data y(n) and generate an estimated echo component r′(n) which is subtracted from the outgoing signal data so as to obtain compensated near-end signal data u(n), the echo cancellation processor including:

a weighting filter W(z) arranged to produce whitened far-end signal data y′(n) by weighted filtering of said far-end data using weighting filter coefficients w(n);

a weighting filter coefficient processor which determines said weighting filter coefficients according to linear predictive coding coefficients derived from the far-end signal data; and

an adaptive transversal filter H(z) having adaptive coefficients h(n) determined according to said whitened far-end signal data and an echo error component e(n) obtained from said compensated near-end signal data, said adaptive transversal filter being operative to generate said estimated echo component by filtering said far-end signal data using said adaptive coefficients;

wherein:

said whitened far-end signal data y′(n) is generated according to y′(n)=y(n)*w(n);

said estimated echo signal is generated according to r′(n)=y(n)*h(n); and

said adaptive coefficients h(n) are determined according to

hₖ(n+1)=hₖ(n)+K.e(n).y′(n−k)/P_{y}(n)

P_{y}(n)=(1−a).P_{y}(n−1)+a.y′(n)²

where n, k are integers, and K, a are constants.

According to the present invention, there is also provided a method for echo cancellation in a communications system having incoming communications signals and outgoing communications signals wherein the outgoing communications signals include an echo signal derived from the incoming communications signals, and wherein the incoming communications signals comprise a series of digital data samples, the method including:

generating weighting filter coefficients based on linear predictive coding coefficients calculated from a block comprising a plurality of sequential samples of the incoming communications signals;

filtering the incoming communications signals through a weighting filter utilising said weighting filter coefficients to produce a weighted incoming communications signals;

generating estimated echo signals by filtering the incoming communications signals through an adaptive transversal filter, the adaptive transversal filter using adaptive filter coefficients; and

subtracting said estimated echo signals from said outgoing communications signals to produce error signals;

wherein said adaptive filter coefficients are determined for each sample in said block on the basis of said weighted incoming communications signals and said error signals.

The present invention further provides an echo canceller for use in a communications system having incoming communications signals and outgoing communications signals wherein the outgoing communications signals include an echo signal derived from the incoming communications signals, and wherein the incoming communication signals comprise a series of digital data samples, the echo canceller including:

a weighting filter coefficient generator for generating weighting filter coefficients based on linear predictive coding coefficients calculated from a block comprising a plurality of sequential samples of the incoming communications signals;

an weighting filter for filtering the incoming communications signals using said weighting filter coefficients to produce weighted incoming communications signals;

an adaptive transversal filter for generating estimated echo signals by filtering the incoming communications signals using adaptive filter coefficients; and

a signal combiner for subtracting said estimated echo signals from said outgoing communications signals to produce error signals;

wherein said adaptive filter coefficients are determined for each sample in said block on the basis of said weighted incoming communications signals and said error signals.

The invention is further described by way of example only with reference to the accompanying drawings in which:

FIG. 1 is a block diagram of an LMS echo canceller;

FIG. 2 is a block diagram of an LMS echo canceller with pre-whitening;

FIG. 3 is representations of speech waveform;

FIG. 4 is representations of speech spectrum and its envelope;

FIG. 5 illustrates exemplary weighting factors γ₂=0.7γ₂=0.9 and p=10;

FIG. 6 is a block diagram of an echo canceller constructed in accordance with the invention;

FIG. 7 is a block diagram of an equivalent structure of the echo canceller of FIG. 6;

FIG. 8 is a block diagram of an equivalent structure of the echo canceller of FIG. 6 with multi-weighting filters;

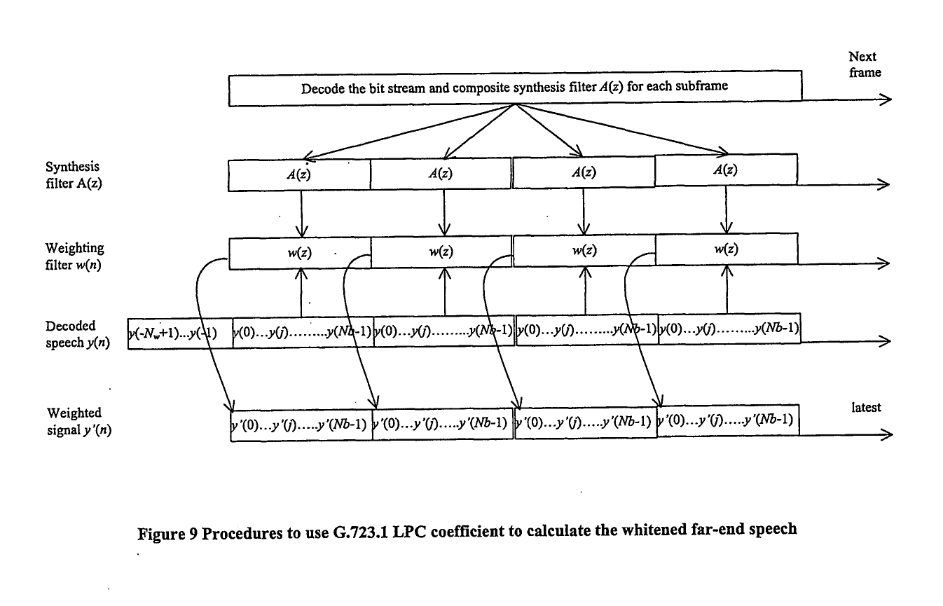

FIG. 9 diagrammatically illustrates procedures for using G.723.1 LPC coefficient to calculate a whitened far-end speech;

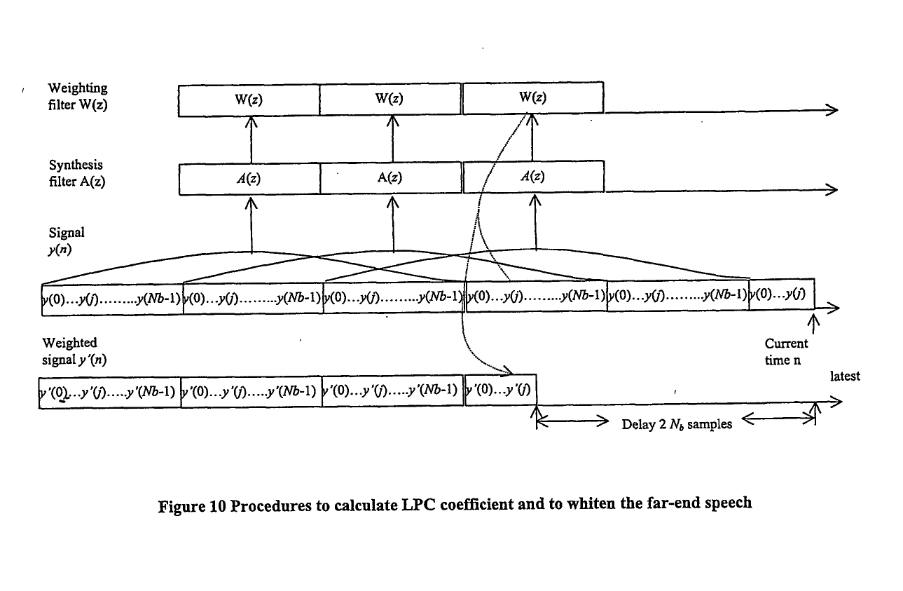

FIG. 10 diagrammatically illustrates procedures for calculating LPC coefficient and to whiten the far-end speech;

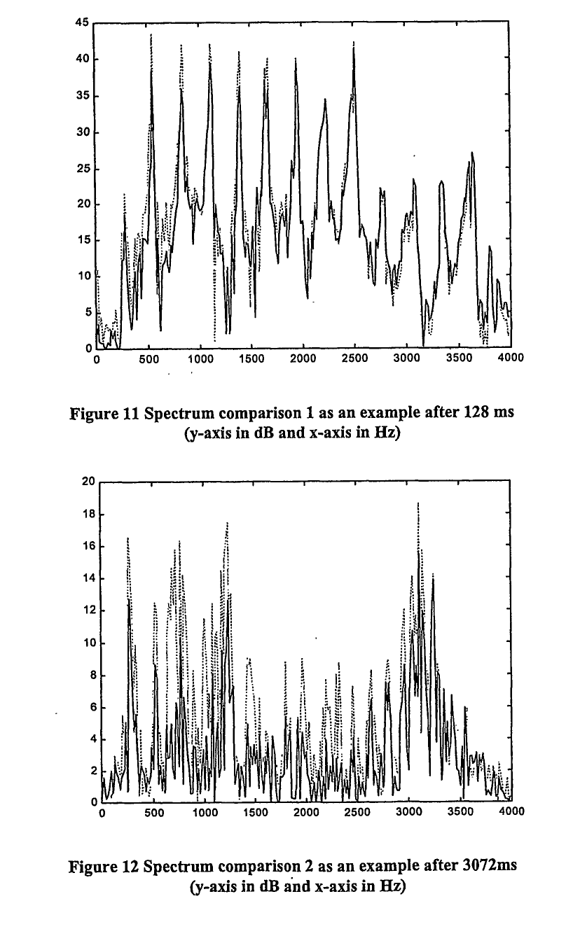

FIG. 11 is an exemplary spectrum comparison, after 128 ms; and

FIG. 12 is an exemplary comparison, after 3072 ms.

FIGS. 6, 7 and 8 illustrate implementations of an echo cancellation system in accordance with embodiments of the invention. FIGS. 6 and 7 are structures for short-tail lengths while FIG. 8 shows a structure for long tail-length applications.

Based on the energy of the spectrum envelope of a speech signal, weighting (whitening) filtering is applied to the input signal for coefficient adaptation. Since the speech signal is pseudo-stationary, multiple weighting adaptive filters may be used to whiten each speech segment in order to achieve better whitening effects if the tail length is long. The adaptive weighting filter coefficients may be calculated from linear prediction coding (LPC) coefficients. For LEC applications, if the decoder is a LPC-type vocoder, the LPC coefficients are at hand and it is not necessary to calculate whitening filter coefficients. On the other hand for non LPC-type codec applications, these LPC coefficients can be calculated using the Levinson-Durbin method. Dynamic weighting filters may be are composed using the LPC coefficients.

After weighting the input signal, the decorrelated far-end signal as well as a non-whitened error signal may be used to update the transversal filter coefficients. Once the adaptive transversal filter coefficients are obtained, the echo signal may be estimated by passing the original far-end signal to the transversal filter, such as is described by Equations 3, 12 and 18.

Broadly, the following steps are performed:

Determination of Weighting Filter Coefficients

1. Buffer N_{rub} samples (e.g. 60) of far-end signal to make up one frame N_{frm} samples (e.g. 180) which consists of current block and two previous blocks. If an LPC vocoder is used in LEC, the block size for calculating whitening filter coefficients is chosen according to vocoder's subframe size, i.e. 60 samples for G.723.1 and 40 samples for G.729.

2. The Levinson-Durbin method is applied to calculate LPC coefficients. For LEC and LPC decoder applications, the LPC coefficients are not calculated from the decoded speech but directly decoded from the bit-stream (Equation 14).

3. Calculate and update weighting filter coefficients (Equation 15).

The abovementioned procedural steps 1-3 are then repeated block by block for the incoming signal.

Updating of Transversal Filter Coefficients and Filtering

4. Filter the far-end signal by this weighting filter. The output of this weighting filter is used to update transversal filter coefficients (Equation 17).

5. Update filter coefficients using weighted far-end signal and non-weighted error signal (Equations 16 and 21).

6. Estimate the echo by filtering the original far-end signal Equation 18).

7. Subtract the estimated echo and send to far-end (Equation 21).

The procedural steps 4-7 are repeated on a sample by sample basis.

### Embodiment

Suitable echo cancellation structures are shown in FIGS. 6 and 8, respectively, for short-tail and long-tail echo path applications. The equivalent structure of FIG. 6 is shown in FIG. 7. In FIG. 8, multiple weighting filters are used for far-end speech. Since speech signal is not stationary, it is preferred to weight the far-end speech signals segmentally. Referring to FIG. 6, an echo cancellation circuit 100 is illustrated in block diagram form. The echo cancellation circuit 100 is provided to reduce or eliminate echo signals which arise at a near-end interface 120. A decoder 110 is provided to receive a far-end bit stream, and decode the bit stream to produce a far-end signal y(n) on a first communications channel 112 which is coupled to the near-end interface 120. The decoder 110 may comprise a component of a linear predictive coding (LPC) vocoder or the like. The first communications channel 112 provides an input to the near-end interface 120, and an output 122 is also provided for passing a near-end signal x(n) from the near-end interface 120 to the far-end communications system. As discussed hereinabove, impedance mismatches and the like which may occur at the near-end interface 120 can cause a portion of the incoming far-end signal y(n) to appear as an echo signal r(n) together with the near-end signal x(n) on the output 122. Accordingly, an estimate of the reflected signal is generated and subtracted from the near-end output using a signal adder 130 to produce a compensated output signal u(n) on a second outgoing communications channel 132. The compensated output signal is passed to encoding circuitry 140, 150 for transmission to the far-end communications system.

A weighting filter 162 is coupled to receive the far-end signal y(n) from the first communications channel 112. The output of the weighting filter 162 is coupled to provide input to an adaptive transversal filter 164. The output of adaptive transversal filter 164 is coupled to the input of an inverse weighting filter 166, which generates the estimated reflection signal −r(n) that is provided to the signal adder 130. A weighting filter coefficient update processor 160 is coupled to receive output from the decoder 110 for generating updated weighting filter coefficients, which are then passed to the weighting filter 162 and inverse weighting filter 166.

FIG. 8 is a block diagram of another embodiment of echo cancellation circuitry according to the present invention, which is adapted for long tail echo path applications. In particular, for long tail echo path applications, it is preferred to apply echo cancellation over several consecutive segments. Accordingly, a plurality of adaptive transversal filters 164 and signal adders 130 are provided sequentially in the transmission path from the near-end interface 120 to the encoder 150. The far end signal y(n) and the output of the weighting filter 162 are provided to the respective adaptive filters 164 through buffer delay components 170.

Symbols

The symbols used in the following are summarised as follows:

n-time index in sample

N-tail length in sample

N_{b}-block or subframe length

N_{frm}-frame length

N_{b}-Number of blocks in N-tail length, N/N_{frm},

N_{w}-weighting filter tap length

Adaptive Weighting Filter

A filter of the kind used for perceptual filtering is used.

Due to non-stationary effects, the long tail length is divided into segments and each segment is applied with its own weighting filter. FIGS. 9 and 10 show the operation of weighting filters.

LPC Vocoder Based Applications

In this application, it is assumed that there is a decoder such as of the types known as ITU-T G.723.1 or G.729, these being LPC-type vocoders. This provides reconstructed LPC coefficients that are ready to use, and so there is no need to calculate them from the linear PCM signal. In this case, the subframe size N_{b} is as same as the vocoder. One example is shown in FIG. 9. In the Figure, only the current frame decoding procedure is shown. The N_{w} historical signal samples of y(n) are used to calculate y′(n) at the very beginning of the frame. N_{w} is the order of weighting FIR filter. For next frame decoding, the same procedure is used.

In the Figure, the first sample falling in each block is denoted by y(0). In each block, the different y(0) may have different values. From the bit stream, the four subframe's LPC filter can be calculated. The weighting filter W(z) is calculated accordingly, based on the applicable A(z). Passing far-end signal y(n) through W(z) yields the weighted signals y′(n).

Non-LPC Vocoder Application

In a non-LPC type application, the LPC coefficients are calculated using the Levinson-Durbin method. For each of the N_{b} samples it is required to update the weighting filter coefficients. There are several ways to update the weighting filter coefficients. One is using one block look ahead and one current block as well as one previous block. One example to update W(z) is shown in FIG. 10.

In FIG. 10, three N_{b} samples are used to calculate LPC coefficients. A windowing technique can be used for three N_{b} samples before computing the LPC coefficients. The delay due to the buffering effect is 2*N_{b} samples. For AEC applications, this extra delay does not greatly affect the audio signals.

Adaptive Transversal Filter

The equivalent structure of FIG. 6 is shown in FIG. 7. These represent the same topology. The coefficients updating is performed as follows.

hₖ(n+1)=hₖ(n)+2μ.e(n).y′(n−k)/P_{y}(n) (16)

$${y}^{′} ( n ) = {y ( n )}^{*} w ( n ) = {\sum }_{k = 0}^{{N}_{w} - 1} w ( k ) y ( n - k ) \qquad ( 17 )$$

\hat{r}(n)=y′(n)*hₖ(n)*w′(n)=y(n)*hₖ(n) (18)

P_{y}(n)=(1−α)P_{y}(n−1)+α.y′(n)² (19)

u(n)=x(n)+r(n)−\hat{r}(n) (20)

e(n)=r(n)−\hat{r}(n) (21)

where w′(n) is the impulse response of the inverse weighting filter 1/W(z). It is assumed that w(n)*w′(n)=δ(n). If truncated at 2p for impulse responses, w(n)*w′(n) is almost identical to δ(n).

In Equation 16, the coefficients are updated with Δhₖ(n+1) upon the previous coefficients hₖ(n). This Δhₖ(n+1) is actually weighted by 1/w(z) which emphasises the high energy frequency components rather than whitening. By this, the procedure is considered to be best described as an adaptive weighting technique rather than whitening. Equation 16 is interpreted as indicated that the far-end signal is whitened and the correction of coefficients are weighted by its speech spectrum envelope, as further described in the following.

For the structure shown in FIG. 8, the updating is as above except that the weighting (whitening) filter is divided into N_{d} segments. Consequently, the notations are modified somewhat. The main idea of this structure is to weight the time-varying far-end signals segmentally in order to achieve better whitening effects.

In the Figure, in segment i(i=0, . . . , Nd−1), the signals or equations are modified as follows:

$${H}_{i} ( z ) = {\sum }_{k = 0}^{{N}_{b} - 1} {h}_{k + {iN}_{b}} ( n ) {z}^{- ( k + {iN}_{b} )} \qquad ( 22 )$$

If define

Wᵢ(z)=Wᵢ₋₁(z)z^{-(i-1)N}^{_{b}}, i≧1 (23)

and the impulse response of Wᵢ(z) is wᵢ(n), the weighted far-end signals is given by

$${y}_{i}^{′} ( n ) = {y ( n - {iN}_{b} )}^{*} {w}_{i} ( n ) = {\sum }_{k = 0}^{{N}_{w} - 1} {w}_{i} ( n ) y ( n - {iN}_{b} - k ) \qquad ( 24 )$$

Coefficients updating is performed by

h_{k+iN}_{_{b}}(n+1)=h_{k+iN}_{_{b}} (n)+2μe(n)y′ᵢ(n−k)/P_{y}(n) (25)

The normalisation power is updated by

P_{y}(n)=(1−α)P_{y}(n−1)+α.y′₀(n)² (26)

The error signals is given by the same Equation 21.

Adaptive Transversal Filter Coefficients Updating

In LMS, the correction part of the transversal filter coefficients is the element of a gradient vector. Referring to FIG. 1 or 6, the gradient vector is computed based on the cost-function or MSE, which is given by

$$\begin{matrix}{\vert e ( n ) \vert}^{2} = {[ r ( n ) - {y ( n )}^{*} {h}_{k} ( n ) ]}^{2} = {\{ r ( n ) - {[ {y ( n )}^{*} w ( n ) ]}^{*} [ {{h}_{k} ( n )}^{*} {w}^{′} ( n ) ] \}}^{2} \\ = {\{ r ( n ) - {[ {y ( n )}^{*} w ( n ) ]}^{*} {h}_{k}^{′} ( n ) \}}^{2} & ( 27 ) \\ where {h}_{k}^{′} ( n ) is defined by & \\ {h}_{k}^{′} ( n ) = {{h}_{k} ( n )}^{*} {w}^{′} ( n ) = {\sum }_{i = 0}^{{N}_{b}} {w}^{′} ( i ) {h}_{k - 1} ( n ) , k = 0 , … , N - 1 & ( 28 )\end{matrix}$$

If we define the vectors as

h(n)=[h₀(n), h₁(n), . . . , hₖ(n), . . . , h_{N-1}(n)]^{T}, (29)

y(n)=[y₀(n), y₁(n), . . . , yₖ(n), . . . , y_{N-1}(n)]^{T}, (30)

h′(n)=[h′₀(n), h′₁(n), . . . , h′ₖ(n), . . . , h′_{N-1}(n)]^{T}, and (31)

y′(n)=[y′₀(n), y′₁(n), . . . , y′ₖ(n), . . . , y′_{N-1}(n)]^{T}, (32)

the vector representation of Equation 1 becomes

h(n+1)=h(n)+μ∇ₕ/P_{y}(n)=h(n)+2μe(n)y(n)/P_{y}(n) (33)

where ∇ₕ=2e(n)y(n), which is the gradient vector and calculated by using partial derivative of MSE of Equation 27.

The direction of ∇ₕ gives the direction of steepest ascent, the magnitude gives the value of the gradient at the point h(n). The LMS algorithm adjusts h(n) by a fraction of the gradient in the above equation.

On the other hand, in this invention, as described by Equation 16, the gradient vector is

∇_{h′}=2e(n)y′(n−k) (34)

The coefficients are updated by

h(n+1)=h(n)+μ∇_{h′}/P_{y}(n)=h(n)+2μe(n)y′(n)/P_{y}(n) (35)

This equation is the same as Equation 16.

The gradient vector ∇_{h′} is a version of ∇ₕ weighted by a speech spectral envelope. In Equations 16 and 28, the correction part of the transversal filter coefficients is weighted by w′(n) or by inverse weighting filter 1/W(Z). The weighted coefficients are allowed to put more weight in formant parts and less weight in valleys of spectrum. This is a type of adaptive weighting.

As an example of the performance comparison, the system shown in a spectrum comparison was made between use of the method of the invention and that of FIG. 1. The results are shown in FIGS. 11 and 12 respectively.

In FIGS. 11 and 12, the curves are the spectra of e(n). The dotted lines represent the spectra of e(n) by using the method of FIG. 1, and the solid lines represent the spectrum of e(n) by using this invention. An improvement in the echo-cancellation performance by several dBs is achieved by the invention.

The invention is generally applicable in the field of telecommunications, audio conferencing and the Internet, and generally wherever echo cancellation is used. It may be applied to both line echo cancellation (LEC) and acoustic echo cancellation (AEC). It is particularly useful in linear prediction coder (LPC) type applications. The greatest advantages of the present invention are obtained in implementation and performance of the echo canceller when it is combined with a speech codec. These advantages are obtained due to the fact that the performance of the echo canceller is improved (e.g., speed of convergence, noise floor level reached, etc.) when it uses some elements from the speech codec system. When these two are combined, the requirements for practical implementation (e.g. MIPS, memory) are reduced.

An example where this technology is particularly appropriate is in Voice-over-IP applications. In this case various speech codec are deployed together with an echo canceller to achieve full-duplex operation. Video and teleconferencing are two other areas where this technology can be applied.

The foregoing detailed description of implementations of the present invention has been presented by way of example only, and is not intended to be considered limiting to the invention as defined in the appended claims.

1. An echo canceller for use in a communications apparatus having an incoming far-end signal and a near-end signal which may include an echo component derived from the far-end signal, the echo canceller comprising: an echo estimator for generating an estimated echo signal, and a signal subtracting means for subtracting the estimated echo signal from said rear-end signal to generate a compensated near-end signal including an echo error signal component, wherein said echo estimator includes a weighting filter arranged to produce a whitened far-end signal by weighted filtering of the incoming far-end signal, and a weighting filter coefficient processor which determines coefficients for the weighting filter according to linear predictive coding coefficients derived dynamically from the incoming far-end signal, the echo estimator further including an adaptive transversal filter having adaptive coefficients determined according to said whitened far-end signal and said error signal component, said adaptive transversal filter being operative to generate said estimated echo signal by filtering said far-end signal using said adaptive coefficients.

2. A communications apparatus, comprising:
an encode/decode processor which generates outgoing signals from compensated near-end signal data for transmission by way of a communications channel and generates far-end signal data from incoming signals received by way of said communications channel; and
an echo cancellation processor coupled to the encode/decode processor for generating estimated echo signal data and subtracting the estimated echo signal data from near-end signal data so as to obtain said compensated near-end signal data, the echo cancellation processor including:
a weighting filter arranged to produce whitened far-end signal data by weighted filtering of said far-end signal data using weighting filter coefficients;
a weighting filter coefficient processor which determines said weighting filter coefficients according to linear predictive coding coefficients derived from the far-end signal data;
an adaptive transversal filter having adaptive coefficients determined according to said whitened far-end signal data and an echo error component obtained from said compensated near-end signal data, said adaptive transversal filter being operative to generate said estimated echo signal data by filtering said far-end signal data using said adaptive coefficients.

3. A communications apparatus according to claim 2, wherein said linear predictive coding coefficients are decoded directly from said incoming signals by said encode/decode processor.

4. A communications apparatus according to claim 3, wherein said encode/decode processor is constructed according to one of ITU-T standards G.723.1 and G.729.

5. A communications apparatus as according to claim 2, including a plurality of adaptive transversal filters coupled in parallel with respectively time delayed inputs for receipt of said far-end signal data and said whitened far-end signal data.

6. An echo compensation processor for use in a communications system in which outgoing signal data for transmission by way of a communications channel comprises near-end signal data x(n) and an echo component r(n) derived from far-end signal data y(n) received by way of said communications channel, the echo compensation processor being coupled to receive said far-end signal data y(n) and generate an estimated echo component r′(n) which is subtracted from the outgoing signal data so as to obtain compensated near-end signal data u(n), the echo cancellation processor comprising:
a weighting filter W(z) arranged to produce whitened far-end signal data y′(n) by weighted filtering of said far-end signal data using weighting filter coefficients w(n);
a weighting filter coefficient processor which determines said weighting filter coefficients according to linear predictive coding coefficients derived from the far-end signal data; and
an adaptive transversal filter H(z) having adaptive coefficients h(n) determined according to said whitened far-end signal data and an echo error component e(n) obtained from said compensated near-end signal data, said adaptive transversal filter being operative to generate said estimated echo component by filtering said far-end signal data using said adaptive coefficients;
wherein:
said whitened far-end signal data y′(n) is generated according to y′(n)=y(n)*w(n);
said estimated echo signal is generated according to r′(n)=y(n)*h(n); and
said adaptive coefficients h(n) are determined according to
hₖ(n+1)=hₖ(n)+K.e(n).y′(n−k)/P_{y}(n)
P_{y}(n)=(1−α).P_{y}(n−1)+α.y′(n)²
where n, k are integers, and K, α are constants.

7. A method for echo cancellation in a communications system having incoming communications signals and outgoing communications signals wherein the outgoing communications signals include an echo signal derived from the incoming communications signals, and wherein the incoming communications signals comprise a series of digital data samples, the method comprising:
generating weighting filter coefficients based on linear predictive coding coefficients calculated from a block comprising a plurality of sequential samples of the incoming communications signals;
filtering the incoming communications signals through a weighting filter utilizing said weighting filter coefficients to produce a weighted incoming communications signals;
generating estimated echo signals by filtering the incoming communications signals through an adaptive transversal filter, the adaptive transversal filter using adaptive filter coefficients; and
subtracting said estimated echo signals from said outgoing communications signals to produce error signals;
wherein said adaptive filter coefficients are determined for each sample in said block on the basis of said weighted incoming communications signals and said error signals.

8. A method as claimed in claim 7, wherein a plurality of adaptive transversal filters are provided, each generating respective estimated echo signals that are subtracted from said outgoing communications signals, the plurality of adaptive transversal filters each using different adaptive filter coefficients.

9. An echo canceller for use in a communications system having incoming communications signals and outgoing communications signals wherein the outgoing communications signals include an echo signal derived from the incoming communications signals, and wherein the incoming communication signals comprise a series of digital data samples, the echo canceller comprising:
a weighting filter coefficient generator for generating weighting filter coefficients based on linear predictive coding coefficients calculated from a block comprising a plurality of sequential samples of the incoming communications signals;
a weighting filter for filtering the incoming communications signals using said weighting filter coefficients to produce weighted incoming communications signals;
an adaptive transversal filter for generating estimated echo signals by filtering the incoming communications signals using adaptive filter coefficients; and
a signal combiner for subtracting said estimated echo signals from said outgoing communications signals to produce error signals;
wherein said adaptive filter coefficients are determined for each sample in said block on the basis of said weighted incoming communications signals and said error signals.

10. An echo canceller as claimed in claim 9, including a plurality of adaptive transversal filters each generating respective estimated echo signals that are, in use, subtracted from said outgoing communications signals, wherein the plurality of adaptive transversal filters each use different adaptive filter coefficients.
